(19) United States
(12) Patent Application Publication
(10) Pub. No.: US 2020/0264094 A1
(43) Pub. Date: Aug. 20, 2020

(54) GAZ ANALYZER WITH PROTECTION FOR OPTICAL COMPONENTS

(71) Applicant: NEO Monitors AS, Norway (NO)

(72) Inventor: Karsten Brink FLOOR, Hadsund (DK)

(21) Appl. No.: 15/774,494

(22) PCT Filed: Nov. 9, 2016
(86) PCT No.: PCT/NO2016/050224

§ 371 Date: May 8, 2018

(30) Foreign Application Priority Data
Nov. 9, 2015 (NO) 20151519

(51) Int. Cl. G01N 21/15; G01N 21/85

(52) U.S. Cl. CPC G01N 21/15; G01N 21/85; G01N 2021/151; G01N 2021/8578; G01N 2021/8571

(57) ABSTRACT

Gas analyzer and method for optical in situ measurements of a gaseous medium with a filter wall for keeping dust outside and a gas cushion to protect possible hazardous components in the gaseous medium.

### TECHNICAL FIELD

The present invention relates to an optical gas analyzer for analysis of gaseous media, and in particular, to a gas analyzer comprising protection of optical components in a hostile medium.

### BACKGROUND OF THE INVENTION

In any process relying on a combustion operation, it is important to know the concentration of some key gas components for process control, emission reporting and safety reasons. These gas components, such as Oxygen, Carbon Monoxide, Nitrogen Oxide, Hydrogen Sulphide, Sulphur Dioxide, Methane and others, can be measured at different locations representing different stages of the combustion process. This means that the conditions experienced at the different locations can vary substantially in terms of temperature level, dust load, and the concentration of the various gas components in the medium. However, regardless of the measuring point and the process conditions accuracy, response time and run factor of the analysis equipment has a major impact on the usability and quality of the measurement.

Two main methods are today used in gas analysis technologies in order to achieve the desired measurements are In Situ analysis and Extractive analysis. Each of these technologies at its present technological stage represents solutions with individual benefits compared to the other.

In Situ analysis systems in the past typically represented benefits in the areas of: faster response time; lower impact on the measured gas; lower cost of investment, installation, operations and maintenance; low contamination of the analysis system; and the capability of measuring hot/wet media and compensating for, e.g., the water content, by analyzing the actual value. However, In Situ systems in the past typically suffered in the areas of: being limited in handling high dust applications; having a lack of easy calibration and validation; having a limited number of gas analysis components measured in one unit; and having a lack of availability of specific gas analysis components.

Extractive analysis systems in the past typically represented benefits in the areas of: being able to handle high dust level gas analysis; easy calibration and validation; having more or less unlimited availability of specific gas analysis components; easy integration of different technologies into one system; and the capability to measure both hot/wet media and cold/dry media, depending on the application. However, Extractive systems in the past typically suffer in the areas of: having slower response time; potential impact on the measured gas; having higher cost of investment, installation, operation and maintenance; potential contamination of the sample system; a more complex system design and requiring a higher level of maintenance.

Several efforts to make a new analysis setup utilizing the various benefits of the two methods have already been attempted, with various capabilities as a result. However none of these attempts have been able to find a successful solution which provides a fast response time with no impact on the measured gas in high dust level processes. In all previous systems which have a similar filter construction to this suggestion and a forced gas flow through this filter, there has not been protection of any optical parts from getting in direct contact with the gas, thereby preventing a potential contamination of optical parts, as the present invention is capable of doing. Other similar systems utilizing a filter combined with purge gas capabilities to protect the analyzer optics, like the present invention, however have not been able to force the gas through the filter into the analyzing area, as they all have been equipped with one or several openings in the filter wall in order to vent out the purge gas and, as a result, have depended on a process flow in the gas medium which they are analyzing in order to analyze correctly.

The patent application JPH11295213A is directed to protection of optical components from pollution related to optical In Situ measurements of emission gases in a furnace. In this patent application, a transparent glass surface located in front of a photo detector and a glass surface located in front of a flood lighting projector, are prevented from being contaminated by forced circulation of gas in front of the glass surfaces through a pipe system with opposing spout and suction ports.

German patent publication DE 1673230 A1 describes an apparatus for measurement of particulates in the exhaust from diesel engines. FIG. 1 of the patent publication describes the measurement concept. The apparatus comprises a light source and a light sensitive detector. The signal measured by the detector varies depending on the amount of light from the light source reaching the detector. The exhaust from the diesel engine will contain varying amounts of particles depending on how the engine is operated. A higher concentration of particles, or higher smoke density, gives less light on the detector and a correspondingly lower detector signal.

The apparatus of the patent publication is arranged so that the exhaust gas comprising both particles and gases enters the measurement tube. The detector and the light source are kept clean using the most common method in this field, based on clean purge air. A pump forces clean air into the system, and this air is directed to the front of the optical components, purging the surfaces to avoid build-up of sediments from the particles. The optical components are kept clean using purged air, but the measurement chamber or tube of the system will contain all parts of the exhaust including particulates, which is what the apparatus is meant to measure. However, this can cause build-up of sediments of particulates in the measurement chamber.

A system according to the present invention is designed to keep the particles outside of the measurement chamber, so as to be capable of operation in process gases with a high dust load.

European patent publication EP 1944598 A1 describes an “Elongated exhaust gas probe”. FIG. 1 of this patent publication describes the arrangement. Process gas is drawn into a measurement space via a filter that blocks particulates from entering the measurement space, which also ensures that optical components and the inner surface of the measurement space are kept free of particulate deposits. However, optical surfaces are exposed to the process gas, which could lead to etching or otherwise damage the optical components in cases where the process gas contains corrosive or sticky gases. EP 1944598 A1 tries to solve this by heating the environment of a measurement housing to prevent formation of condensate which could lead to corrosion. In this way, the corrosive gases are not deposited on the optical surfaces by condensation, and therefore, the risk of damaging the optical surfaces is reduced.

An arrangement according to the present invention purges the optical surfaces with clean air to protect them from etching and, at the same time, reduces power consumption of the device. However, this could in the normal case lead to dilution of the gas to be measured resulting in a false reading. This has been solved in the present invention by combined purge and suction features in both ends of the probe.

Thus, there is a need for a method of obtaining accurate gas analysis without contaminating the optical system being used, having a fast response time and a high run factor with negligible impact on the measured gas in processes with high dust levels, as this will provide a major benefit in the usability and quality of the analytical result in a large number of applications in various industries, with lower maintenance cost for the end user.

### SUMMARY OF THE INVENTION

The apparatus disclosed in the present invention has all the normal general benefits of an In Situ system, and adds the capability to prevent contamination of an optical analyzer system, and the capability to handle high dust loads with a fast response time. The system also is simple to calibrate or validate during operation behind the pressure control chamber filter walls. The layout of the system is designed so it is capable of taking advantage of existing apparatus, and the expected new releases of light based analyzers capable of measuring new gas components, e.g., developments within laser based analyzers and others.

The apparatus of the present invention comprises an analyzer positioned outside the environment to be analyzed, and an elongate volume with walls that filters the medium to be analyzed so that dust and other particles are prevented from entering the volume. In front of an optical face is a cushion body of protecting gas, e.g., air, or a gas such as nitrogen. Between this cushion and the medium to be analyzed is a volume that extracts both the protecting gas and gas medium from the volume to be analyzed. In this way, the gas to be analyzed is forced through the filter while leaving unwanted dust and other particles on the outside of the filter. At the same time, optical faces are protected from possible contamination by a neutral cushion.

One embodiment of the present invention is a gas analyzer for optical In Situ measurements, the gas analyzer comprising a pipe comprising a filter wall, a measurement chamber inside the pipe, and a purging chamber comprising a gas inlet, adapted to create a pressure difference between a gaseous medium outside the analyzer and a gaseous medium to be measured.

Another embodiment of the present invention is a gas analyzer comprising a purging chamber comprising a gas inlet, adapted to produce a gas cushion comprising a gas cushion medium, for protecting an optical component from hazardous components in the gaseous medium to be measured.

Another embodiment of the present invention is a gas analyzer prepared to clean a filter wall by applying gas for cleaning from at least one of the gas outlet and the gas inlet.

Yet another embodiment of the present invention is a gas analyzer adapted for In Situ validation or calibration by introducing a reference gas into the pressure chamber from at least one of the gas outlet and the gas inlet.

In an embodiment of the present invention, a gas analyzer for optical In Situ measurements is provided. The analyzer comprises a pipe, comprising a filter wall, and a measurement chamber in the center of the pipe, adapted to measure process gas with particulates being kept outside the filter wall.

Optical components at each longitudinal end of the pipe are used for the measurements. A purging chamber comprising a gas inlet is positioned on both longitudinal sides between the optical components and a suction chamber. The purging chamber is adapted to produce a gas cushion with a gas cushion medium of purge gas. This gas may be, e.g., clean air for protecting optical components from corrosive components in the process gas. A suction chamber comprising a gas outlet is positioned between the purging chamber and the measurement chamber. This suction chamber is adapted to produce suction for generally preventing the gas cushion medium from entering the measurement chamber.

In another embodiment, the gas inlet is in gas communication with a peripheral circular annulus located in the purging chamber. The annulus comprises an inward oriented circular slit operating as a valve with some resistance to a flow of gas, adapted to producing a circularly symmetrical gas cushion protecting the optical components from corrosive components in the process gas.

In another embodiment of the gas analyzer of the present invention, the gas inlet is in gas communication with a peripheral circular annulus located in the purging chamber. The annulus comprises circularly symmetrically positioned valves with some resistance to a flow of gas, and adapted to produce a circularly symmetrical gas cushion. This gas cushion is intended to protect the optical components from corrosive components in the process gas.

In yet another embodiment of the present invention, the gas outlet is in gas communication with a peripheral circular annulus located in the suction chamber. The annulus comprises an inwardly oriented circular slit operating as a valve with some resistance to a flow of gas, adapted to remove excess purge gas from the circularly symmetrical gas cushion in order to prevent excess purge gas from entering the measurement chamber.

In still another embodiment of the gas analyzer of the present invention, the gas outlet is in gas communication with a peripheral circular annulus located in the suction chamber. The annulus comprises circularly symmetrically positioned valves with some resistance to a flow of gas, and are adapted to remove excess purge gas from the circularly symmetrical gas cushion. This is to prevent excess purge gas from entering the measurement chamber.

In still another embodiment of the present invention, the gas analyzer is adapted to clean the filter wall by applying high pressure purge gas, e.g., gas with more than 2 bars to the inlet.

In still another embodiment of the present invention, the gas analyzer is adapted for In Situ calibration by introducing a reference gas into the measurement chamber from at least one of the gas outlet and the gas inlet.

In another embodiment of the present invention, a method for using the gas analyzer is provided. This is done by applying an over pressure to the purge gas supplied to the purging chamber through the gas inlet, and subsequently applying an under pressure to the gas, e.g., a mixture of purge gas and process gas from the gas outlet, resulting in the gas-flow being sucked out of the suction chamber through the outlet being higher than the gas-flow of the purge gas supplied to the gas inlet (21).

In yet another embodiment of the present invention, a method is provided for the gas-flow being sucked out of the suction chamber through the outlet being more than 100 percent higher than the gas-flow of purge gas supplied to the gas inlet.

In still another embodiment of the present invention, a method is provided for the gas-flow being sucked out of the suction chamber through the outlet being more than 200 percent higher than the gas-flow of purge gas supplied to the gas inlet.

### BRIEF DESCRIPTION OF THE DRAWINGS

The present invention will now be described in detail with reference to the accompanying drawings, in which:

FIG. 1 shows a cross section view of the apparatus of the present invention in normal operation;

FIG. 2 shows the same view of the invention as in FIG. 1, but arrows indicate how clean gas moves and how the gaseous media to be analyzed moves in relation to the different parts of the present invention; and

FIG. 3 shows a cross section view of the apparatus of the present invention where a reference gas is used to calibrate the invention or blow back gas used to clean the filter of the invention.

All the figures are schematic, not necessary to scale, and generally only show parts which are necessary in order to elucidate the invention, wherein other parts may be omitted or merely suggested.

REFERENCE SIGNS RELATED TO THE DRAWINGS

| | |
|---|---|
| 1 | Gas analyzer |
| 2 | Optical beam |
| 3 | Pipe |
| 4 | Measurement chamber |
| 5 | Filter wall |
| 21 | Gas inlet |
| 22 | Gas outlet |
| 61 | Optical transmitter |
| 62 | Optical element |
| 63 | Optical reflector |
| 64 | Optical receiver |
| −2P | Gas mix |
| −P | Process gas without particulates |
| P | Process gas |
| +P | Clean gas |
| A | Purging chamber |
| B | Suction chamber |

### DETAILED DESCRIPTION

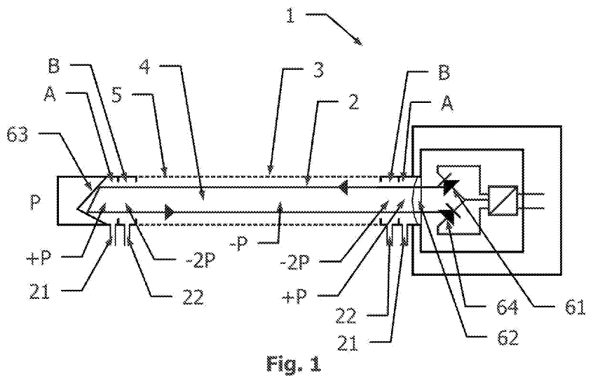

An embodiment of the apparatus of the present invention will now be discussed with reference to FIG. 1.

A filter wall 5 of a pipe 3 separates a surrounding process gas P to be analyzed from a measurement chamber 4 in which actual measurements are performed. Contrary to the part of the wall of pipe 3 surrounding the measurement chamber 4, the part of the wall of pipe 3 surrounding a purging chamber A and a suction chamber B is preferably non-permeable for gases.

A light based In Situ analyzer 1 is only able to operate if the light 2 can get through the process gas in the entire measuring path. If a dust load is too high, analysis is not possible.

A gas penetrable filter wall 5 of a pipe 3 can establish a dust free measuring path inside the pipe core, and solves the problem of passing light inside a process gas with high dust density.

The pressure in the measurement chamber 4 is lower than outside the pipe 3 in the surrounding process gas P. Besides the difference in pressure, the surrounding process gas P, and the process gas without particulates −P to be analyzed, differ generally in that the filter wall 5 filters the process gas P so that dust and other particles are left out from the process gas without particulates to be analyzed, −P.

The difference in pressure forces gas contents of process gas P through the filter wall 5 and reduces any delay in moving the process gas P to the measurement chamber 4.

An optical beam 2 is transmitted from the optical transmitter 61 inside the pipe 3 in the direction of the longitudinal axis of the pipe 3. The optical beam 2 passes through an optical component 62, passes through a purging chamber A and a suction chamber B, and then enters the measurement chamber 4. It then passes through a second suction chamber B and a second purging chamber A. Thereafter, the beam 2 gets reflected in an optical reflector 63, and the optical beam 2 returns in the opposite direction and finally arrives at an optical receiver where the beam 2 is converted to an electrical signal that is analyzed in a way that is known in the art. The optical reflector is typically a corner reflector well known in the field.

Optical components facing the measurement chamber 4 are prepared to be protected by a cushion of clean gas +P. The volume where the cushion of clean gas +P is adapted to be positioned is purging chamber A. The clean gas +P is introduced through a gas inlet 21. Not presented in the drawings is how the gas coming from the inlet 21 gets distributed in purging chamber A. In order for the cushion to operate according to the present invention, it is desirable to distribute the gas evenly around the circumference of the purging chamber A. There are different ways known in the field to distribute gas evenly around a cross section of a pipe, and this is not shown in detail in the drawings. One example of evenly distributing gas around a pipe is to arrange a channel along the inner wall circumference of the pipe 3, perpendicular to the axis of the pipe 3 and connected to the gas inlet 21. The protecting gas comes from the gas inlet 21, moves to the channel and then penetrates a diffusor curtain on the inside of the channel on its way towards the axis of the purging chamber A in the pipe 3.

In the measurement chamber 4, between the purging chamber A intended for a gas cushion and the measurement chamber 4, there is a suction chamber B. In operation, gas from the gas cushion as well as process gas without particulates −P are sucked into the suction chamber B. The construction of suction chamber B is similar to that of the purging chamber A. In a typical example, a channel, not presented in the drawings, is arranged along the inner wall circumference of the pipe 3 perpendicular to the center of the pipe 3 and connected to the gas outlet 22. Both clean gas +P from the purging chamber A and process gas without particulates −P from the measurement chamber 4 are sucked out through an infuser curtain on the inside of the channel and further through the gas outlet 22.

Condensing or sticking gasses in the process gas can contaminate the optical parts of a light based In Situ analysis system.

A properly designed purging section in front of the optical parts in each end of the probe solves the problem of process gas coming into contact with the surfaces of the optical components, and thereby potentially contaminating them, which in turn will prevent the light of the analyzer from passing freely.

However, purge gas mixing with process gas meant for analysis inside the filter will result in false analysis results.

Clean gas +P from the purging chamber A must continuously be removed so that the clean gas +P does not mix with the process gas −P to be analyzed inside the measurement chamber 4, thereby making the measurements false.

A properly designed suction chamber B in each end of the probe pipe 3 between the purging chamber A and the measurement chamber 4 solves the problem of mixing clean gas +P with process gas without particulates −P.

There is not necessarily any physical wall between the purging chamber A, the suction chamber B and the measurement chamber 4 in the pipe 3. The transversal walls indicated by vertical lines, without reference numbers in the drawings, between the suction chambers B and respective purging chamber A and measurement chamber 4, can be envisioned as “virtual walls,” symbolizing that, in normal operation, gas generally does not migrate from the process gas without particulates −P to the clean gas +P, nor does gas from the cushion with clean gas +P migrate with the process gas without particulates −P, except inside the suction chamber as a gas mix −2P.

The pressure of the gas mix −2P, being lower than both in the clean gas +P and in the process gas without particulates −P, also reduces the gas volume/pressure needed to create a gas cushion in front of the optical element. The optical reflector insures that the measuring path length inside the measurement chamber 4 is defined at a fixed value.

In operation, the operation of the “virtual walls” is controlled by a controller, not indicated in the drawings, by controlling the flow of gas through inlets 21 and outlets 22. The pressure of gas media −2P, −P, P and +P may advantageously be used as inputs to the controller.

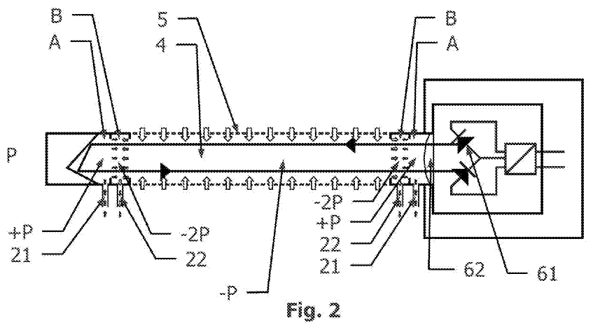

FIG. 2 illustrates the gas analyzer 1 when it is analyzing gas. The arrows indicated with a white interior refer to gas from the gaseous medium P entering through the filter wall 5 and into the measurement chamber 4. The arrows with white interior then pass the virtual walls and into the suction chambers B. In the end, these arrows exit through gas outlets 22 and do not reach the optical components 61, 62.

FIG. 2 also shows the clean gas +P, indicated with black arrows, flowing through the gas inlet and into the purging chambers A. This gas cushion medium continues through the virtual wall between chambers A and B and leaves suction chamber B through gas outlet 22 together with the process gas P.

Process gas without particulates −P in measurement chamber 4 does not enter the purging chamber A.

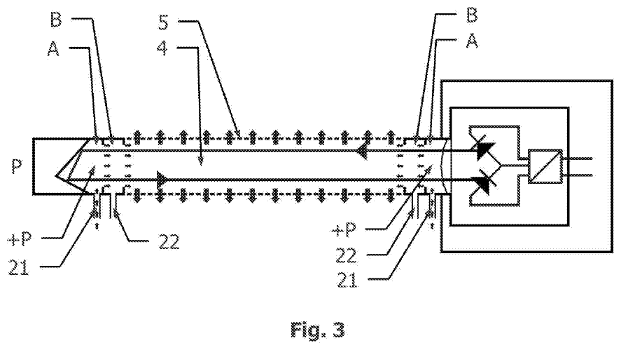

With reference to FIG. 3, by registering the pressure of the gaseous medium P and of the pressure of the process gas without particulates −P, the controller may be used to monitor a build-up of dust and other particles on the filter wall 5 outside of the measurement chamber 4 due to the fact that the pressure difference between the two pressures represents the build-up of dust and other particles.

If the build-up of dust and other particles on the filter wall 5 reaches a predetermined level, it is optionally possible to stop the normal gas analysis operation, and instead start a cleaning operation to clean the filter wall 5. This can be done by introducing a cleaning gas, e.g., air, nitrogen or some other gas, to the measurement chamber 4 through either or both of the gas inlet 21 and the gas outlet 22. This gas may then blow back and away dust and other particles when the gas penetrates the filter wall 5 with sufficient force the opposite direction from performing normal gas analysis.

As indicated in FIG. 3, the gas analyzer 1 may be validated and calibrated by introducing a reference gas into the pressure chamber 4 from at least one of the gas outlet 22 and the gas inlet 21. The introduction of the reference gas will lead to an over pressure inside the measurement chamber 4 relative to the environment outside the filter wall 5, in order to fill up the measurement chamber 4 with reference gas.

The gas analyzer 1 of the present invention is described with an optical reflector reflecting the optical beam 2 in the opposite direction. In an equivalent alternative embodiment of the present invention, not shown in the drawings, the optical reflector 63 is not present, but instead, the optical receiver is position on the opposite side of the axis of pipe 3 to where the optical transmitter 61 is positioned. In this way, the optical beam 2 passes the pipe 3 just once before it gets analyzed.

In another embodiment of the invention, dust particles that may deteriorate the operation of the gas analyzer are not present in the gaseous medium. In this case, the filter wall 5 is not deployed, and the cushion produced by purging chamber A, suction chamber B, gas inlet 21 and gas outlet 22 is used just for the protection of optical components 62, 63 as described previously.

For the optical light based In Situ analyzer to calculate the actual concentration of process gas that passes it, it is required to know the actual distance that the light travels through the process gas without particulates −P.

If the purging chamber A in front of the optics and suction chamber B between the purging chamber A and the measurement chamber 4 is not well defined, the length of the process gas inside the probe/filter construction is undefined.

To solve the problem of defining the length of the path of the measurement chamber 4 that the process gas occupies, a specific design defining the purge feed through the purge gas inlet 21 and the suction outlet 22 must be provided.

The details of chamber A in the following two paragraphs are not depicted in the drawings. In the present invention, the gas inlet 21 of the purging chamber A is in gas communication with a peripheral circular annulus located in the purging chamber A. This volume is further in gas communication with the purging volume in the center of chamber A through a circularly symmetrical valve, e.g., a circular slit, a number of apertures or similar opening, in order to evenly distribute a gas cushion medium inside the purging chamber A. In other words, this operates as a built-in circular nozzle in front of the optics that is designed to protect the optics and push the purged gaseous medium in the direction towards the measurement chamber. The purging chamber A and the suction chamber B are in gas communication with each other perpendicularly to the center axis of the pipe 3.

Similarly, the gas outlet 22 of the suction chamber B is in gas communication with a peripheral circular annulus located in the suction chamber B. This volume further is in gas communication with the suction volume of chamber B through a circularly symmetrical valve, e.g., a circular slit, a number of apertures or similar opening, in order to evenly evacuate the clean gas +P from the purging chamber A. In other words, this operates as a built-in circular suction device to evacuate the clean gas +P from the purging chamber A and prevent this gaseous medium from entering the measurement chamber 4. For the present invention, it is also of importance that the suction gas comprises gaseous medium from the measurement chamber in order to ensure that the gaseous medium outside the pipe 3 moves through the filter wall 5 to the measurement chamber 4.

Finally, a working ratio between the gas-flow of purge gas per second through the gas inlets 21 compared to the gas-flow suction gas per second through the gas outlets 22, which is required in order to make a well-defined purge zone and a well-defined process gas zone for the light based In Situ analyzer to efficiently operate, is important. The difference between the gas-flow out of the outlets 22 and the inlets 21 defines the gas-flow through the filter wall and into the measurement chamber.

The ratio between the suction volume and the purge volume must be more than one-to-one, and preferably more than one-to-two or more.

1. A gas analyzer for optical In Situ measurements of process gas including dust and other particulates, the gas analyzer comprising:
a pipe;
a measurement chamber for measurement of process gas in a center of the pipe; and
optical components at each longitudinal end of the pipe, wherein
the pipe comprises a filter wall separating surrounding process gas from the measurement chamber such that the dust and other particulates are left out as process gas without particulates moves to the measurement chamber;
a purging chamber comprising a gas inlet positioned on both longitudinal sides between the optical components and a suction chamber prepared for producing a gas cushion with a clean gas, for protecting the optical components from corrosive components in the process gas without particulates;
a suction chamber for producing a suction scheme for the clean gas from the purging chamber and the process gas without particulates from the measurement chamber forming in the suction chamber a gas mix preventing the clean gas from entering the measurement chamber;
the suction chamber comprising gas outlet being positioned between the purging chamber and the measurement chamber for producing a suction scheme for preventing the clean gas from entering the measurement chamber; and
a controller controlling flow of gas through the inlets and the outlets, wherein the pressure of gas media is used as inputs to the controller.

2. The gas analyzer according to claim 1, wherein the gas inlet is in gas communication with a peripheral circular annulus in the purging chamber, the annulus comprising an inward oriented circular slit operating as a valve, prepared to produce a circularly symmetrical gas cushion protecting the optical components from corrosive components in the process gas without particulates.

3. The gas analyzer according to claim 1, wherein the gas inlet is in gas communication with a peripheral circular annulus in the purging chamber, the annulus comprising circularly symmetrically positioned valves for producing a circularly symmetrical gas cushion protecting the optical components from corrosive components in the process gas without particulates.

4. The gas analyzer according to claim 1, wherein the gas outlet is in gas communication with a peripheral circular annulus in the suction chamber, the annulus comprising an inward oriented circular slit operating as a valve for removing excess purge gas, circularly symmetrical from the gas cushion, in order to prevent the excess purge gas from entering the measurement chamber.

5. The gas analyzer according to claim 1, wherein the gas outlet is in gas communication with a peripheral circular annulus in the suction chamber, the annulus comprising circularly symmetrically positioned valves for removing excess purge gas circularly symmetrical from the gas cushion in order to prevent the excess purge gas from entering the measurement chamber.

6. The gas analyzer according to claim 1, for cleaning said filter wall by applying high pressure purge gas in excess of 2 bars, to the inlet.

7. The gas analyzer according to claim 1, for In Situ calibration by introducing a reference gas into the measurement chamber from at least one of, the gas outlet and the gas inlet.

8. Method for using a gas analyzer according to claim 1, comprising:
applying an over pressure to the clean gas supplied to the purging chamber through the gas inlet;
applying an under pressure to a mixture of purge gas and process gas from the gas outlet of the suction chamber that results in the gas-flow being sucked out of the suction chamber through the outlet being higher than the gas-flow of the purge gas supplied to the gas inlet; and
using the controller to control the flow of gas through the inlet and the outlet, using the pressure of gas media as inputs to the controller so as to prevent the clean gas from entering the measurement chamber.

9. The method according to claim 8, wherein the gas-flow being sucked out of the suction chamber through the outlet is more than 100 percent higher than the gas-flow of purge gas supplied to the gas inlet.

10. The method according to claim 8, the wherein gas-flow being sucked out of the suction chamber through the outlet is more than 200 percent higher than the gas-flow of purge gas supplied to the gas inlet.

11. The gas analyzer according to claim 2, wherein the gas outlet is in gas communication with a peripheral circular annulus in the suction chamber, the annulus comprising an inward oriented circular slit operating as a valve for removing excess purge gas, circularly symmetrical from the gas cushion, in order to prevent the excess purge gas from entering the measurement chamber.

12. The gas analyzer according to claim 3, wherein the gas outlet is in gas communication with a peripheral circular annulus in the suction chamber, the annulus comprising an inward oriented circular slit operating as a valve for removing excess purge gas, circularly symmetrical from the gas cushion, in order to prevent the excess purge gas from entering the measurement chamber.

13. The gas analyzer according to claim 2, wherein the gas outlet is in gas communication with a peripheral circular annulus in the suction chamber, the annulus comprising circularly symmetrically positioned valves for removing excess purge gas, circularly symmetrical from the gas cushion, in order to prevent the excess purge gas from entering the measurement chamber.

14. The gas analyzer according to claim 3, wherein the gas outlet is in gas communication with a peripheral circular annulus in the suction chamber, the annulus comprising circularly symmetrically positioned valves for removing excess purge gas, circularly symmetrical from the gas cushion, in order to prevent the excess purge gas from entering the measurement chamber.

15. The gas analyzer according to claim 2, for cleaning said filter wall by applying high pressure purge gas in excess of 2 bars, to the inlet.

16. The gas analyzer according to claim 3 for cleaning said filter wall by applying high pressure purge gas in excess of 2 bars, to the inlet.

17. The gas analyzer according to claim 5, for In Situ calibration by introducing a reference gas into the measurement chamber from at least one of, the gas outlet and the gas inlet.

18. The gas analyzer according to claim 6, for In Situ calibration by introducing a reference gas into the measurement chamber from at least one of, the gas outlet and the gas inlet.

19. The gas analyzer according to claim 13, for In Situ calibration by introducing a reference gas into the measurement chamber from at least one of, the gas outlet and the gas inlet.

20. The gas analyzer according to claim 15, for In Situ calibration by introducing a reference gas into the measurement chamber from at least one of, the gas outlet and the gas inlet.
